(19) United States
(12) Patent Application Publication
(10) Pub. No.: US 2025/0136820 A1
(43) Pub. Date: May 1, 2025

(54) RADIATIVE COOLING PAINT HAVING IMPROVED SOLAR REFLECTIVITY

(71) Applicant: Korea University Research and Business Foundation, Seoul (KR)

(72) Inventor: Heon LEE, Seoul (KR)

(73) Assignee: Korea University Research and Business Foundation, Seoul (KR)

(21) Appl. No.: 18/693,765

(22) PCT Filed: Jun. 7, 2023
(86) PCT No.: PCT/KR2023/007724

§ 371 Date: Mar. 20, 2024

(30) Foreign Application Priority Data
Jun. 8, 2022 (KR) 10-2022-0069730
Jun. 5, 2023 (KR) 10-2023-0072233

(51) Int. Cl. C09D 5/33; C09D 7/40; C09D 7/61; C09D 7/65

(52) U.S. Cl. CPC C09D 5/004; C09D 7/61; C09D 7/65; C09D 7/68; C09D 7/69

(57) ABSTRACT

The present invention relates to a radiative cooling paint consisting of ceramic fine particles as pigments, a polymer resin as a binder, and a solvent. According to the present invention, a substrate is coated with the radiative cooling paint, and then a paint film layer is formed. The paint film layer performs a radiative cooling function by preventing energy inflow from incident sunlight by maximizing reflection of incident sunlight; minimizing absorption of incident sunlight; and maximizing emission of long-wavelength infrared light corresponding to 8 μm to 13 μm and increasing energy discharge through emission of long-wavelength infrared light, and pores with a volume of 3% to 50% are formed inside the paint film layer to enhance reflection of incident sunlight without reducing emission of long-wavelength infrared light.

### TECHNICAL FIELD

The present invention relates to a radiative cooling paint with improved sunlight reflectivity, and more specifically, to a radiative cooling paint being capable of preventing the inflow of energy from incident sunlight by increasing the reflectivity of incident sunlight and being capable of performing a radiative cooling function by increasing energy discharge through the emission of long-wavelength infrared light.

### BACKGROUND ART

Generally, energy is used for cooling. For example, general-purpose cooling devices such as refrigerators and air conditioners convert electrical energy (compressor) into mechanical energy, compress a refrigerant, and then perform cooling by absorbing heat generated when the compressed refrigerant expands.

That is, energy must be used to perform cooling, which involves moving heat from a location with a lower temperature to a location with a higher temperature.

On the other hand, according to radiative cooling, heat exchange occurs outside the Earth's atmosphere rather than around a cooling body through a spontaneous and energy-free process called infrared light emission. Accordingly, radiative cooling is a new technology that performs cooling without consuming energy.

That is, heat exchange by radiation from a cooling body to the outside of the Earth's atmosphere is achieved by thermal radiation (infrared light emission), which is a spontaneous process that does not require energy.

When a person approaches a hot object, the person feels heat even when the surrounding air is not warm, which is a method of transferring heat energy by radiation.

Thermal radiation is a heat transfer method that does not require direct contact with a heat source or an intermediate material. According to thermal radiation, heat transfer occurs through the emission of electromagnetic waves, so no medium is needed, and heat is transmitted to locations over astronomical distances at the speed of light.

All objects with a temperature above the absolute temperature (0 K) have thermal energy, and thermal radiation occurs from these objects. At this time, the emitted radiant energy is determined depending on the temperature, surface area, and surface properties of the object.

The key point in zero-energy radiative cooling is to reflect incident sunlight as much as possible without absorbing the incident sunlight, and to effectively discharge heat energy contained in an object out of the Earth's atmosphere.

For radiative cooling, the heat energy of an object is emitted as long-wavelength infrared light (called sky window section) with a wavelength of 8 μm to 13 μm that is not absorbed by the Earth's atmosphere.

Infrared light with wavelengths other than 8 μm to 13 μm wavelengths is absorbed by carbon dioxide and water vapor present in the atmosphere while passing through the Earth's atmosphere, so heat transfer does not occur between objects on the Earth's surface and the outer space.

For radiative cooling, it is necessary to emit infrared light effectively, which requires physical properties that effectively absorb infrared light to be emitted.

In particular, in order for a material to perform radiative cooling even during the day when sunlight is present and the temperature of the material becomes lower than the surrounding area, the absorption, reflection, transmission, and radiation of light in each wavelength band must be independently and effectively controlled.

In most cases, the main heat source is incident sunlight. Since the heat of sunlight arrives in the form of UV-visible light-near infrared light, for radiative cooling during the day, the inflow of heat caused by sunlight should be blocked as much as possible by reflecting incident sunlight as much as possible without absorbing the incident sunlight (UV-visible light-near infrared light), and heat contained in an object must be effectively emitted from the surface in the form of infrared light.

In this way, when more heat energy is emitted than the energy of incident sunlight, the temperature of the object may be reduced compared to the ambient temperature without consuming any energy.

For example, during a sunny day, the internal temperature of a black car, which absorbs light well, increases significantly. However, the internal temperature of a white car, which reflects light well, increases relatively less.

When the surface of a car reflects light in the wavelength range of UV-visible light-near infrared light, i.e., incident sunlight, as much as possible rather than absorbing the light, and thus the inflow of heat energy caused by sunlight is minimized, at the same time, when sunlight is not reflected 100% and a greater amount of heat energy than inflowed heat energy is emitted through emission of infrared light of 8 μm to 13 μm that is not absorbed by the earth's atmosphere, a car may be cooled to a temperature lower than the ambient temperature.

All objects emit their thermal energy to the outside in the form of light, and the wavelength of the emitted light is determined by the surface temperature of the object.

The reason the sun emits light in the UV-visible light-near infrared light wavelength range to the outside is because the surface temperature of the sun reaches 6000° C.

Objects with a surface temperature of several tens of degrees Celsius emit long-wavelength infrared light with a wavelength of several to tens of microns (e.g., 5 μm to 100 μm) to the outside.

When the surface of an object is coated with a material that suppresses the emission of long-wavelength infrared light or reflects emitted light, heat loss due to the emission of long-wavelength infrared light may be reduced, thereby obtaining a warming effect.

This phenomenon is already being applied to winter clothing. Likewise, when infrared light is easily emitted from the surface of an object, heat emission by thermal radiation occurs effectively in the object.

In addition to nitrogen, oxygen, and argon, small amounts of water vapor and carbon dioxide exist in the Earth's atmosphere. Water vapor and carbon dioxide absorb some wavelengths of long-wavelength infrared light emitted by the Earth to the outside and suppress the emission of this light to the outside.

A representative example is the “greenhouse effect.” When the concentration of carbon dioxide in the Earth's atmosphere increases, the emission of long-wavelength infrared light emitted from the Earth is interrupted, preventing heat from being discharged from the Earth into space, causing the Earth's temperature to increase.

However, long-wavelength infrared light with a wavelength of 8 μm to 13 μm, called the sky window, is not absorbed by the Earth's atmosphere and is easily emitted out of the Earth's atmosphere.

For reference, the temperature of outer space is −270° C., which is close to the absolute temperature of 0 K, so it is a natural phenomenon that long-wavelength infrared light is emitted into space from the surface of the Earth, where the surface temperature is tens of degrees Celsius, and heat is transferred.

When a material effectively radiates thermal energy thereof as long-wavelength infrared light with a wavelength of 8 μm to 13 μm, called a sky window, radiative cooling occurs more effectively.

Conventional paint-type radiative cooling materials (devices) require a thick film thickness and low binder content (high ceramic fine particle content) to sufficiently reflect sunlight.

To prepare a radiative cooling paint, ceramic fine particles with appropriate physical properties must be selected and the particle size thereof must be determined to maximize light scattering.

A material having a high refractive index in the sunlight region and a high extinction coefficient (k) in the sky window region is selected.

Even when Mie scattering is maximized by controlling the size of ceramic fine particles and selecting a material with a high refractive index in the incident sunlight region (UV-vis-NIR), when a coating layer is thin due to limited light scattering, the radiative cooling ability and hiding power of a radiative cooling paint are limited.

### DISCLOSURE

### Technical Problem

Therefore, the present invention has been made in view of the above problems, and it is one object of the present invention to provide a radiative cooling paint capable of reducing the thickness of a paint film layer required to implement radiative cooling performance and forming pores inside the paint film layer so that light scattering occurs more actively inside the radiative cooling paint to reduce the painting workability and painting difficulty of the radiative cooling paint.

It is another object of the present invention to provide a radiative cooling paint exhibiting excellent radiative cooling performance even in small thicknesses and having excellent painting workability as thick coating is not necessary.

It is still another object of the present invention to provide a radiative cooling paint having excellent radiative cooling performance due to effective light scattering by pores even when the content of a binder increases and being capable of improving the durability of a coating layer with the increased binder content.

It is still another object of the present invention to provide a radiative cooling paint having high radiative cooling power regardless of day or night, being capable of minimizing the absorption of incident sunlight even during the day when the intensity of sunlight is high when applied to structures and buildings installed outdoors, and having improved radiative cooling performance by maintaining heat release through the emission of long-wavelength infrared light.

It is yet another object of the present invention to provide a radiative cooling paint capable of suppressing temperature increase due to internal heat accumulation in data centers or communication equipment and relay facilities installed outdoors.

### Technical Solution

In accordance with one aspect of the present invention, provided is a radiative cooling paint consisting of ceramic fine particles as pigments, a polymer resin as a binder, and a solvent, wherein a substrate is coated with the radiative cooling paint, and then a paint film layer is formed, wherein the paint film layer performs a radiative cooling function by preventing energy inflow from incident sunlight by maximizing reflection of incident sunlight; minimizing absorption of incident sunlight; and maximizing emission of long-wavelength infrared light corresponding to 8 μm to 13 μm and increasing energy discharge through emission of long-wavelength infrared light, and pores with a volume of 3% to 50% are formed inside the paint film layer to enhance reflection of incident sunlight without reducing emission of long-wavelength infrared light.

In the paint film layer, the ceramic fine particles may be homogeneously mixed with the polymer binder to form the pores on surfaces of the ceramic fine particles and form composites of the ceramic fine particles and the pores.

The composites may enhance reflection of incident sunlight without reducing emission of long-wavelength infrared light at at least one of interfaces between the ceramic fine particles and the pores and interfaces between the pores and the polymer binder, and may reduce at least one of a thickness of the paint film layer and a content of the ceramic fine particles as a volume of the pores increases.

The ceramic fine particles may include at least one of TiO₂, Al₂O₃, h-BN, ZrO₂, SiO₂, CaCO₃, BaSO₄, MgO, Y₂O₃, YSZ, BeO, MnO, ZnO, SiC, and AlN, and may include at least one polymer fine particle of PVDF, PTFE, and ETFE.

Sizes of the ceramic fine particles and the pores may be 0.1 μm to 5 μm.

The ceramic fine particles may be selected considering a refractive index and extinction coefficient for incident sunlight and a extinction coefficient for long-wavelength infrared light.

The polymer resin may include at least one of a polyurethane resin, an alkyd resin, an acrylate resin, PVC, PE, an acrylic resin, DPHA, and a fluorine resin.

A weight ratio of the ceramic fine particles to the polymer resin may be x:1, and x may be 0.15 to 3.

The paint film layer may be formed to have a thickness of 300 μm or less.

The radiative cooling paint may further include at least one additive of a conditioning agent and a photoinitiator to improve painting workability.

### Advantageous Effects

The present invention can provide a radiative cooling paint capable of reducing the thickness of a paint film layer required to implement radiative cooling performance and forming pores inside the paint film layer so that light scattering occurs more actively inside the radiative cooling paint to reduce the painting workability and painting difficulty of the radiative cooling paint.

The present invention can provide a radiative cooling paint exhibiting excellent radiative cooling performance even in small thicknesses and having excellent painting workability as thick coating is not necessary.

The present invention can provide a radiative cooling paint having excellent radiative cooling performance due to effective light scattering by pores even when the content of a binder increases and being capable of improving the durability of a coating layer with the increased binder content.

The present invention can provide a radiative cooling paint having high radiative cooling power regardless of day or night, being capable of minimizing the absorption of incident sunlight even during the day when the intensity of sunlight is high when applied to structures and buildings installed outdoors, and having improved radiative cooling performance by maintaining heat release through the emission of long-wavelength infrared light.

The present invention can provide a radiative cooling paint capable of suppressing temperature increase due to internal heat accumulation in data centers or communication equipment and relay facilities installed outdoors.

### DESCRIPTION OF DRAWINGS

FIG. 1 is a drawing explaining the concept of a radiative cooling element and radiative cooling paint.

FIGS. 2 and 3 are drawings explaining a radiative cooling paint with improved sunlight reflectivity according to one embodiment of the present invention.

FIGS. 4A and 4B are diagrams explaining the optical properties of a radiative cooling paint according to one embodiment of the present invention.

FIG. 5 includes electron microscope images of a radiative cooling paint according to one embodiment of the present invention.

### BEST MODE

Hereinafter, preferred embodiments of the present invention will be described in detail with reference to the accompanying drawings.

However, it should be understood that the present invention is not limited to the embodiments according to the concept of the present invention, but includes changes, equivalents, or alternatives falling within the spirit and scope of the present invention.

In the following description of the present invention, detailed description of known functions and configurations incorporated herein will be omitted when it may make the subject matter of the present invention unclear.

In addition, the terms used in the specification are defined in consideration of functions used in the present invention, and can be changed according to the intent or conventionally used methods of clients, operators, and users. Accordingly, definitions of the terms should be understood on the basis of the entire description of the present specification.

In description of the drawings, like reference numerals may be used for similar elements.

The singular expressions in the present specification may encompass plural expressions unless clearly specified otherwise in context.

In this specification, expressions such as “A or B” and “at least one of A and/or B” may include all possible combinations of the items listed together.

Expressions such as “first” and “second” may be used to qualify the elements irrespective of order or importance, and are used to distinguish one element from another and do not limit the elements.

It will be understood that when an element (e.g., first) is referred to as being “connected to” or “coupled to” another element (e.g., second), the first element may be directly connected to the second element or may be connected to the second element via an intervening element (e.g., third).

As used herein, “configured to” may be used interchangeably with, for example, “suitable for”, “ability to”, “changed to”, “made to”, “capable of”, or “designed to” in terms of hardware or software.

In some situations, the expression “device configured to” may mean that the device “may do˜” with other devices or components.

For example, in the sentence “processor configured to perform A, B, and C”, the processor may refer to a general purpose processor (e.g., CPU or application processor) capable of performing corresponding operation by running a dedicated processor (e.g., embedded processor) for performing the corresponding operation, or one or more software programs stored in a memory device.

In addition, the expression “or” means “inclusive or” rather than “exclusive or”.

That is, unless mentioned otherwise or clearly inferred from context, the expression “x uses a or b” means any one of natural inclusive permutations.

Terms, such as “unit” or “module”, etc., should be understood as a unit that processes at least one function or operation and that may be embodied in a hardware manner, a software manner, or a combination of the hardware manner and the software manner.

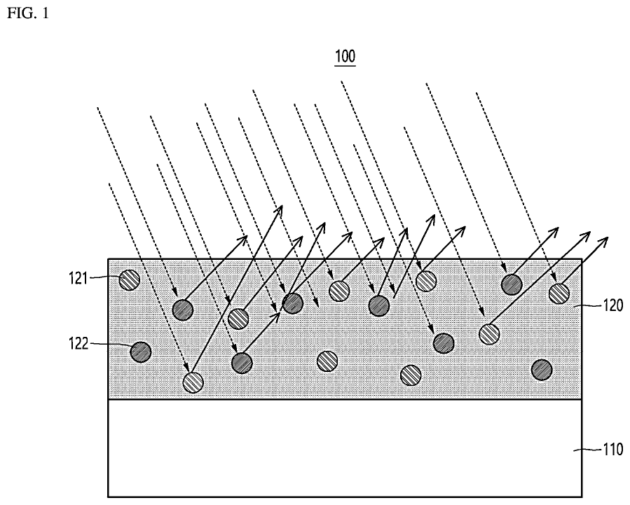

FIG. 1 is a drawing explaining the concept of a radiative cooling element and radiative cooling paint.

FIG. 1 illustrates a radiative cooling element that is related to the radiative cooling paint of the present invention and is formed using a conventional radiative cooling paint that implements radiative cooling performance.

FIG. 1 illustrates a radiative cooling element 100 manufactured using a radiative cooling paint according to the prior art.

The radiative cooling element 100 includes a paint film layer 120 formed on a substrate 110, and the paint film layer 120 is formed based on a radiative cooling paint composed of ceramic fine particles 121 and ceramic fine particles 122 as pigments, a polymer resin as a binder, and a solvent.

Radiative cooling paints are limited because light scattering occurs only at the interface of ceramic fine particles and polymer composites with different refractive indices, but various types of radiative cooling elements are being studied.

Previously, a radiation cooling element in the form of a multilayer thin film deposited on a substrate was proposed. A silver (Ag) thin film was deposited on a substrate to reflect incident sunlight, and a multilayer thin film of materials that were transparent to incident sunlight and capable of absorbing and emitting long-wavelength infrared light was laminated thereon to construct a device.

In addition, a radiative cooling element in the form of a polymer film was proposed in which a silver (Ag) thin film is deposited on one side of the polymer film for sunlight reflection and ceramic fine particles are dispersed inside the film for long-wavelength infrared light emission.

Both of these devices used specular reflection, which reflects incident sunlight like a mirror by using a metal thin film such as silver (Ag) to reflect incident sunlight.

Instead of specular reflection, radiative cooling may be performed by reflecting all wavelengths of incident sunlight without absorbing incident sunlight using white scattered reflection, which does not have a mirror-like appearance by scattering and reflecting light for all wavelengths of incident sunlight.

In particular, white scattering reflection does not use expensive silver thin films, so manufacturing costs are reduced. Additionally, since there is no deterioration in product performance due to deterioration of a silver thin film, the lifespan of a product increases. Accordingly, white scattered reflection is more suitable for manufacturing radiative cooling elements.

To efficiently cause white scattering reflection, ceramic microparticles of a size similar to a wavelength to be reflected are needed, and a binder material to connect these microparticles is also needed. A polymer material is a very suitable binder material.

Polymers are very competitive materials with advantages such as mass production, low price, and easy control of various physical properties.

Accordingly, when a zero-energy radiative cooling element is constructed using a polymer, various products may be manufactured at low cost and processability may also be improved.

Many polymer resins and ceramic fine particles have a high emission rate in the sky window corresponding to 8 μm to 13 μm, and emit incident sunlight without absorbing the incident sunlight.

By combining only these materials, a white radiative cooling element may be manufactured. Since a polymer resin and ceramic fine particles are combined, the radiative cooling element may also be implemented in the form of “paint”.

That is, a common form of paint is composed of various polymer resins and ceramic fine particles dissolved and dispersed in a solvent.

These paints are applied (coated) to various surfaces to form a paint film, and the formed film reflects incident sunlight as much as possible, minimizes absorption, and maximizes the emission of 8 μm to 13 μm long-wavelength infrared light to perform radiative cooling. In this case, these paints are radiative cooling paints.

Compared to various types of radiative cooling elements, the advantage of a radiative cooling paint is that the radiative cooling paint is applied on any surface on which a paint may be applied to form a film, and the formed film performs radiative cooling, allowing for a variety of applications.

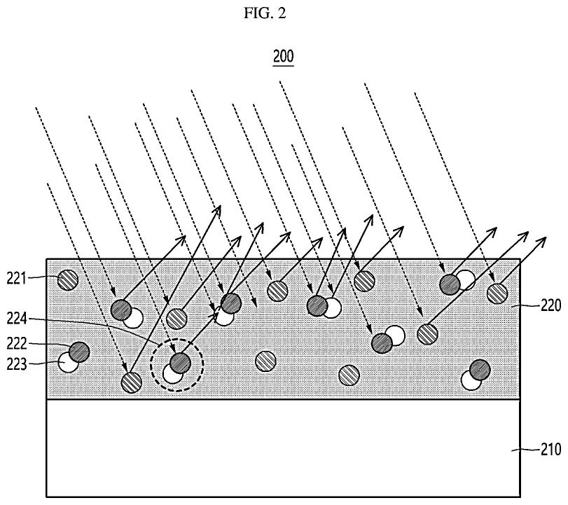

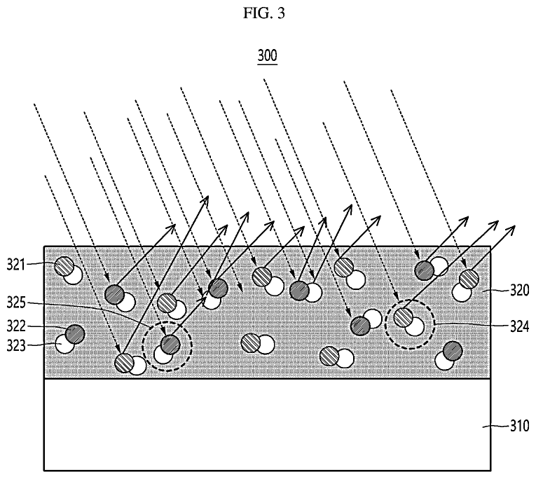

FIGS. 2 and 3 are drawings explaining a radiative cooling paint with improved sunlight reflectivity according to one embodiment of the present invention.

FIGS. 2 and 3 illustrate a radiative cooling paint in which pores are formed inside a paint film layer and light scattering is enhanced by the pores according to one embodiment of the present invention.

FIG. 2 illustrates a case in which only one ceramic fine particle type among a plurality of ceramic fine particle types is created as a composite in a radiative cooling element formed using the radiative cooling paint according to one embodiment of the present invention.

In addition, FIG. 3 illustrates a case in which a plurality of ceramic fine particle types are both created as composites in the radiative cooling element formed using the radiative cooling paint according to one embodiment of the present invention.

For example, the composite may enhance reflection of incident sunlight without reducing the emission of long-wavelength infrared light at at least one of the interfaces between ceramic fine particles and pores and the interfaces between pores and a polymer binder, and may reduce at least one of the thickness of a paint film layer and the content of ceramic fine particles as the volume of pores increases.

For example, the composite may be a composite of ceramic fine particles and pores.

Referring to FIG. 2, a radiative cooling element 200 according to one embodiment of the present invention is formed of a radiative cooling paint.

The radiative cooling paint is composed of ceramic fine particles as pigments, a polymer resin as a binder, and a solvent, and a substrate 210 is coated with the radiative cooling paint to form a paint film layer 220.

The ceramic fine particles may include first ceramic fine particles 221 and second ceramic fine particles 222.

The ceramic fine particles may include at least one of TiO₂, Al₂O₃, h-BN, ZrO₂, SiO₂, CaCO₃, BaSO₄, MgO, Y₂O₃, YSZ, BeO, MnO, ZnO, SiC, and AlN and at least one polymer fine particle of PVDF, PTFE, and ETFE.

The first ceramic fine particles 221 and the second ceramic fine particles 222 may be different materials among the ceramic fine particle materials described above.

For example, the size of ceramic fine particles may be 0.1 μm to 5 μm.

The ceramic fine particles may be selected considering the refractive index and extinction coefficient for incident sunlight and the extinction coefficient for long-wavelength infrared light.

In the case of a radiative cooling paint, to effectively reflect incident sunlight, ceramic fine particles for scattering light and a polymer composite for combining the ceramic fine particles are required.

At this time, as the difference in refractive index between the ceramic fine particles and the polymer increases, light scattering is promoted and scattering reflection occurs more effectively.

For effective radiative cooling, 90% or more of incident sunlight must be reflected, so the concentration of ceramic fine particles that scatter and reflect incident light must be high, and the thickness of a coating layer made of ceramic fine particles and polymer composites must be above a predetermined value.

When 223 pores with a size similar to that of the ceramic fine particles are uniformly present in a coating layer composed of the ceramic fine particles and the polymer composites, light is refracted due to high refractive index difference at the boundary between the pores 223 and the polymer composite and the boundary between the pores and the ceramic fine particles, promoting light scattering. Accordingly, the thickness of the coating layer for reflection of 90% of incident sunlight may be reduced and the concentration of ceramic fine particles may be reduced.

In general, when preparing a paint, it is advantageous to reduce the content of the ceramic fine particles and the thickness of the paint film layer.

According to one embodiment of the present invention, the paint film layer 220 prevents energy inflow from incident sunlight and performs a radiative cooling function by reflecting incident sunlight as much as possible, minimizing absorption of incident sunlight, maximizing the emission of long-wavelength infrared light corresponding to 8 μm to 13 μm, and increasing energy discharge through the emission of long-wavelength infrared light.

In addition, to enhance the reflection of incident sunlight without reducing the emission of long-wavelength infrared light, the volume of the pores 223 formed inside the paint film layer 220 may be between 3% and 50%.

According to one embodiment of the present invention, in the paint film layer 220, the ceramic fine particles are treated with a hydrophilic or hydrophobic substance depending on a solvent, and are homogeneously mixed with a polymer binder to form the pores 223 on the surface of the ceramic fine particles, forming composites 224 of the second ceramic fine particles 222 and the pores.

The pores 223 may be formed both when the ceramic fine particles are subjected to hydrophilic and hydrophobic treatments and when the ceramic fine particles are not subjected to hydrophilic and hydrophobic treatments.

According to one embodiment of the present invention, when the pores 223 in the paint film layer 220 of the radiative cooling element 200 are larger than a certain volume, scattering of incident sunlight is promoted and all light is reflected. However, when the pore volume fraction increases excessively, the mechanical properties of the coating layer may deteriorate.

Light scattering in the radiative cooling element 200 formed by the radiative cooling paint occurs at the interfaces between the ceramic fine particles and the polymer composites, the interfaces between the ceramic fine particles and the pores, and the interfaces between the pores and the polymer composites. Thus, compared to the case without pores, the thickness of the coating layer for a certain amount of light scattering reflection may be reduced or the required content of ceramic fine particles may be reduced.

Referring to FIG. 3, a radiative cooling element 300 according to one embodiment of the present invention is formed of a radiative cooling paint.

The radiative cooling paint is composed of ceramic fine particles as pigments, a polymer resin as a binder, and a solvent, and a substrate 310 is coated with the radiative cooling paint to form a paint film layer 320.

The ceramic fine particles may include first ceramic fine particles 321 and second ceramic fine particles 322.

The ceramic fine particles may include at least one of TiO₂, Al₂O₃, h-BN, ZrO₂, SiO₂, CaCO₃, BaSO₄, MgO, Y₂O₃, YSZ, BeO, MnO, ZnO, SiC, and AlN, and may include at least one polymer fine particle of PVDF, PTFE, and ETFE.

The first ceramic fine particles 321 and the second ceramic fine particles 322 may be different materials among the ceramic fine particle materials described above.

For example, the size of the ceramic fine particles may be 0.1 μm to 5 μm.

The ceramic fine particles may be selected considering the refractive index and extinction coefficient for incident sunlight and the extinction coefficient for long-wavelength infrared light.

According to one embodiment of the present invention, in the radiative cooling paint for forming the paint film layer 320, the polymer resin may include at least one of a polyurethane resin, an alkyd resin, an acrylate resin, PVC, PE, an acrylic resin, DPHA, and a fluorine resin.

The weight ratio of the ceramic fine particles to the polymer resin may be x:1. Here, x may be 0.15 to 3.

According to one embodiment of the present invention, the radiative cooling paint may be a radiative cooling paint in which light scattering is further enhanced by pores 323.

For example, the size of the pores 323 may be 0.1 μm to 5 μm.

For example, in the paint film layer 320, light reflection is promoted by mixing the ceramic fine particles with the pores 323 whose size is similar to that of the ceramic fine particles. In this case, even when the content of the ceramic particles in the radiative cooling paint is reduced, high light reflection and radiative cooling performance may be achieved.

That is, using the radiative cooling paint in which the ceramic fine particles are mixed with pores whose size is similar to that of the ceramic fine particles, the paint film layer is formed. In this case, even when the content of the ceramic particles is reduced, high light reflection and radiative cooling performance may be achieved.

Since light scattering of the radiative cooling paint according to one embodiment of the present invention occurs at the interfaces between the ceramic fine particles and the polymer composites, the interfaces between the ceramic fine particles and the pores 323, and the interfaces between the pores 323 and the polymer composites, compared to the case without the pores 323, the thickness of the coating layer for a certain amount of light scattering reflection may be reduced or the required content of ceramic fine particles may be reduced.

A mixture of polymer particles such as PVDF, PTFE, and ETFE, ceramic fine particles such as TiO₂, Al₂O₃, h-BN, ZrO₂, SiO₂, CaCO₃, BaSO₄, MgO, Y₂O₃, YSZ, BeO, MnO, ZnO, SiC, and AlN, and a polymer resin such as a polyurethane resin, a fluorine resin, a polyethylene resin, a polyacrylate resin, PDMS, and PVC effectively reflects incident sunlight (UV-vis-NIR) without absorbing the incident sunlight and has high absorption across the entire sky window of 8 μm to 13 μm. Accordingly, the mixture has a radiative cooling function.

In addition, this mixture is homogenized by a solvent to form a paint that may be easily applied to various surfaces.

Since the polymer particles and the ceramic fine particles have different refractive indices from polymer resins, the polymer particles and the ceramic fine particles may scatter incident light to reduce absorption of incident sunlight and increase reflection.

The substrate 210 or the substrate 310 may be installed in data centers or communication equipment or relay facilities installed outdoors, and may be a surface of equipment due to internal heat accumulation.

Accordingly, the present invention may provide a radiative cooling paint capable of suppressing temperature increase due to internal heat accumulation in data centers or communication equipment and relay facilities installed outdoors.

In addition to single particles, the ceramic fine particles may include core shell particles composed of heterogeneous ceramic materials or empty microparticles with an empty interior.

When pores are added, compared to simply consisting of the ceramic fine particles and the polymer binder (composite), light scattering is further promoted because light scattering occurs not only at the interfaces between the ceramic particles and the polymer binder, but also at the interfaces between the polymer binder and the pores and the interfaces between the ceramic particles and the pores.

Since the ceramic fine particles have a refractive index of about 2.0 or more, the polymer binder has a refractive index of 1.4 to 1.6, and the pores have a refractive index of 1.0, light scattering by the pores may be achieved more effectively.

By adding a photoinitiator, a thermal initiator, or a conditioning agent to a polymer resin such as a polyurethane resin, a fluorine resin, a polyethylene resin, a polyacrylate resin, PDMS, and PVC, the mechanical properties, gloss, and dryness of the paint film and the dispersibility of the polymer (ceramic) microparticles may be improved.

To improve painting workability, the radiative cooling paint may further include at least one additive of a conditioning agent and a photoinitiator.

According to one embodiment of the present invention, the thickness of the paint film layer 320 may be 300 μm or less.

When the content of the polymer binder increases, i.e., when the content of the ceramic fine particles decreases, there is a problem in that sunlight reflection decreases and sunlight transmission increases.

However, in general, as the polymer binder content increases, painting workability is improved and the surface of the paint film becomes more beautiful.

There is a need to reduce the painting workability and painting difficulty of the radiative cooling paint by reducing the minimum coating layer thickness required to realize radiative cooling performance.

To achieve this, light scattering must occur more actively inside the radiative cooling paint.

In the radiative cooling element 300 according to one embodiment of the present invention, to achieve sufficient incident sunlight reflection even with the reduced thickness of the paint film layer 320, additional light scattering may be triggered in addition to the scattering of only the ceramic fine particles and polymer binder of the conventional radiative cooling paint.

In the radiative cooling paint according to one embodiment of the present invention, by forming first composites 324 and second composites 325 so that pores with a size similar to that of the ceramic fine particles are distributed inside the paint film layer 320, light scattering may occur between the pores and the ceramic fine particles and between the pores and the polymer binder.

According to one embodiment of the present invention, the first composites 324 may be the composites of the first ceramic fine particles 321 and the pores 323, and the second composites 325 may be the composites of the second ceramic fine particles 322 and the pores 323.

The refractive index of the pores is 1.0, and the difference in refractive index between the polymer binder and the ceramic fine particles is large, so light scattering is very effective around the pores. Accordingly, sufficiently high sunlight reflectance and low sunlight transmission may be provided even in the thinly formed paint film layer 320.

Even when a small amount of pores are contained, the sky window emission rate is not affected at all.

More specifically, when the pores 323 exist within the paint film layer 320, light scattering occurs actively, so light does not reach the deep part of the paint film layer 320 and is reflected. However, in the absence of pores, light scattering is reduced, so light reaches the depth of the coating layer, and more absorbing particles are seen, which increases absorption and decreases reflection.

Compared to the conventional radiative cooling paint or commercialized insulation, the radiative cooling paint according to one embodiment of the present invention has superior radiative cooling performance by reducing the absorption of incident sunlight, maximizing reflection, and promoting the emission of infrared light from 8 μm to 13 μm.

To increase reflection of incident sunlight and reduce absorption of incident sunlight, the first composites 324 and the second composites 325 including the pores 323 are uniformly distributed inside the paint film layer 320.

Due to the influence of pores present inside the paint film layer 320, light scattering is promoted and reflection of incident light increases. Light does not reach the deep part of the coating layer and is scattered and reflected at the top of the coating layer, thereby reducing absorption.

When a water-soluble paint using water as a solvent is used to form pores inside the paint film layer 320, by making the surface of the ceramic fine particles hydrophobic (lipophilic), pores are formed on the surface of the ceramic fine particles when the ceramic fine particles are mixed and homogenized with a polymer binder and a solvent.

Likewise, in the case of an oil-based paint using oil as a solvent, by making the surface of the ceramic fine particles hydrophilic (lipophobic), pores are formed on the surface of the ceramic fine particles when the ceramic fine particles are mixed and homogenized with a polymer binder and a solvent.

Such manipulation of the surface of ceramic fine particles may be performed on a part and all of the ceramic fine particles, and may be implemented on some types of ceramic fine particles or all types of ceramic fine particles. Through manipulation, the concentration of pores may be adjusted.

In general, ceramic fine particles are naturally hydrophilic, but these ceramic fine particles may be treated with a solution containing stearic acid to modify the surface properties thereof to hydrophobicity.

The radiative cooling paint may be a material that has a large difference in refractive index from a polymer resin as a binder to effectively scatter and reflect incident sunlight.

That is, a material with a high refractive index value is selected, and a material with a high bandgap energy value that is transparent to incident sunlight is selected.

Accordingly, the present invention may provide a radiative cooling paint capable of reducing the thickness of a paint film layer required to implement radiative cooling performance and forming pores inside the paint film layer so that light scattering occurs more actively inside the radiative cooling paint to reduce the painting workability and painting difficulty of the radiative cooling paint.

In addition, the present invention may provide a radiative cooling paint exhibiting excellent radiative cooling performance even in small thicknesses and having excellent painting workability as thick coating is not necessary.

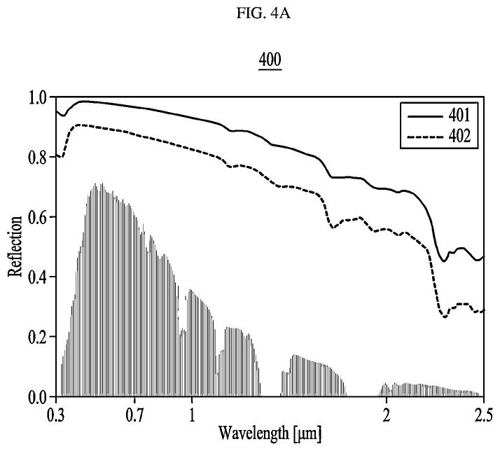

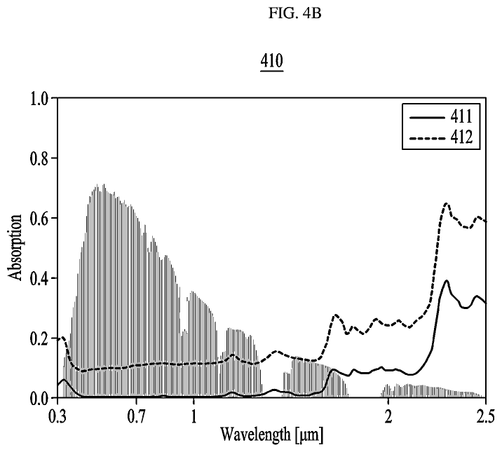

FIGS. 4A and 4B are diagrams explaining the optical properties of a radiative cooling paint according to one embodiment of the present invention.

FIG. 4A compares the present invention with the prior art regarding reflectance among the optical properties of the radiative cooling paint according to one embodiment of the present invention.

Referring to FIG. 4A, in a graph 400, the reflectance of a sample 401 based on the radiative cooling paint according to the present invention that forms a paint film layer including pores is compared with the reflectance of a sample 402 according to the prior art.

FIG. 4B compares the present invention with the prior art regarding absorption among the optical properties of the radiative cooling paint according to one embodiment of the present invention.

Referring to FIG. 4B, in a graph 410, the absorption of a sample 411 based on the radiative cooling paint according to the present invention that forms a paint film layer including pores is compared with the absorption of a sample 412 according to the prior art.

Regarding the graph 400 and the graph 410, a radiative cooling paint was prepared by mixing Yttria-stabilized zirconia (YSZ) microparticles with a particle size of 0.4 μm to 0.6 μm with a Teflon polymer binder. One specimen was prepared by low-speed stirring at 1000 rpm, and the other specimen was prepared by high-speed stirring at 2000 rpm.

Glass substrates were coated with the two radiative cooling paint specimens prepared in this way, and the optical properties thereof were measured. The results are shown in the graph 400 and the graph 410. Here, the specimens prepared by low-speed stirring correspond to the sample 401 and the sample 411 according to the present invention, and the specimens prepared by high-speed stirring correspond to the sample 402 and the sample 412 according to the prior art.

As shown in the graph 400 and the graph 410, compared to the sample 402 and the sample 412, the sample 401 and the sample 411 exhibit high reflectance and low absorption in all wavelength ranges of incident sunlight.

In the sample 401 and the sample 411, the presence of pores promotes light scattering and increases reflection. In the sample 402 and the sample 412, the relatively few pores promote light scattering less effectively. Accordingly, reflection due to light scattering is reduced, and light penetrates deeper into the paint film layer, which increases absorption.

Accordingly, the present invention may provide a radiative cooling paint having excellent radiative cooling performance due to effective light scattering by pores even when the content of a binder increases and being capable of improving the durability of a coating layer with the increased binder content.

In addition, the present invention may provide a radiative cooling paint having high radiative cooling power regardless of day or night, being capable of minimizing the absorption of incident sunlight even during the day when the intensity of sunlight is high when applied to structures and buildings installed outdoors, and having improved radiative cooling performance by maintaining heat release through the emission of long-wavelength infrared light.

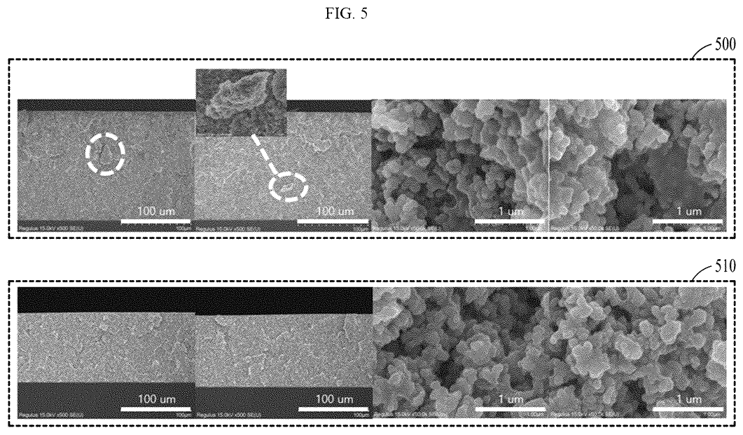

FIG. 5 includes electron microscope images of a radiative cooling paint according to one embodiment of the present invention.

FIG. 5 shows electron microscope images of the radiative cooling paint according to one embodiment of the present invention.

As shown in a first electron microscope image 500 of FIG. 5, in the case of the radiative cooling paint containing pores due to low-speed stirring, agglomerates of a size of 20 microns are observed.

In addition, as shown in a second electron microscope image 510, such agglomerates are not observed in a specimen that does not containing pores due to high-speed stirring.

As shown in the first electron microscope image 500 and the second electron microscope image 510, which are high magnification electron microscope images, compared to the paint specimen containing pores due to low-speed stirring, in the case of the paint specimen that does not containing pores due to high-speed stirring, few pores, which correspond to empty spaces behind particles, are observed.

Both specimens show similar sky window reflectance of 94% to 95%, but since the reflectance of incident sunlight in the specimen stirred at low speed is high, the specimen exhibits a high radiative cooling ability of over 100 W.

According to one embodiment of the present invention, the selection and composition of the ceramic fine particles of the radiative cooling paint are determined so that the radiative cooling paint has a high refractive index and low extinction coefficient in sunlight, has a high extinction coefficient in the sky window, and has high sunlight reflection, low sunlight transmission, and high sky window emission even at thin thickness.

For example, radiative cooling power may be improved by using a radiative cooling paint with a refractive index of 1.7 or more and a bandgap of 5 eV or more at a visible light wavelength of 550 nm.

For example, the radiative cooling paint may be a paint material in powder form.

To improve the workability of the radiative cooling paint, various additives (e.g., conditioning agent, photoinitiator, etc.) may be added.

A transparent top coat layer may be added on the top of the paint film layer formed with the radiative cooling paint to improve the performance of the coating layer.

An undercoat layer and a middle layer may be added to the bottom of the paint film layer formed with the radiative cooling paint to improve bonding strength with the substrate.

Instead of conventional paints, the radiative cooling paint according to one embodiment of the present invention may be used in buildings, container boxes, antenna boxes, cooling towers, water piping, automobiles, hard hats, etc. Additionally, the radiative cooling paint according to one embodiment of the present invention may be used in all product lines that require cooling.

In addition, since the components of the radiative cooling paint are similar to those of the conventional paint, the radiative cooling paint may be implemented by partially changing the forming materials.

In the above-described specific embodiments, elements included in the invention are expressed in singular or plural in accordance with the specific embodiments shown.

It should be understood, however, that the singular or plural representations are to be chosen as appropriate to the situation presented for the purpose of description and that the above-described embodiments are not limited to the singular or plural constituent elements. The constituent elements expressed in plural may be composed of a single number, and constituent elements expressed in singular form may be composed of a plurality of elements.

In addition, the present invention has been described with reference to exemplary embodiments, but it should be understood that various modifications may be made without departing from the scope of the present invention.

Therefore, the scope of the present invention should not be limited by the embodiments, but should be determined by the following claims and equivalents to the following claims.

1. A radiative cooling paint consisting of ceramic fine particles as pigments, a polymer resin as a binder, and a solvent,
wherein a substrate is coated with the radiative cooling paint, and then a paint film layer is formed,
wherein the paint film layer performs a radiative cooling function by preventing energy inflow from incident sunlight by maximizing reflection of incident sunlight; minimizing absorption of incident sunlight; and maximizing emission of long-wavelength infrared light corresponding to 8 μm to 13 μm and increasing energy discharge through emission of long-wavelength infrared light, and
pores with a volume of 3% to 50% are formed inside the paint film layer to enhance reflection of incident sunlight without reducing emission of long-wavelength infrared light.

2. The radiative cooling paint according to claim 1, wherein, in the paint film layer, the ceramic fine particles are homogeneously mixed with the polymer binder to form the pores on surfaces of the ceramic fine particles and form composites of the ceramic fine particles and the pores.

3. The radiative cooling paint according to claim 2, wherein the composites enhance reflection of incident sunlight without reducing emission of long-wavelength infrared light at at least one of interfaces between the ceramic fine particles and the pores and interfaces between the pores and the polymer binder, and reduces at least one of a thickness of the paint film layer and a content of the ceramic fine particles as a volume of the pores increases.

4. The radiative cooling paint according to claim 1, wherein the ceramic fine particles comprise at least one of TiO₂, Al₂O₃, h-BN, ZrO₂, SiO₂, CaCO₃, BaSO₄, MgO, Y₂O₃, YSZ, BeO, MnO, ZnO, SiC, and AlN, and comprise at least one polymer fine particle of PVDF, PTFE, and ETFE.

5. The radiative cooling paint according to claim 4, wherein sizes of the ceramic fine particles and the pores are 0.1 μm to 5 μm.

6. The radiative cooling paint according to claim 4, wherein the ceramic fine particles are selected considering a refractive index and extinction coefficient for incident sunlight and a extinction coefficient for long-wavelength infrared light.

7. The radiative cooling paint according to claim 1, wherein the polymer resin comprises at least one of a polyurethane resin, an alkyd resin, an acrylate resin, PVC, PE, an acrylic resin, DPHA, and a fluorine resin.

8. The radiative cooling paint according to claim 1, wherein a weight ratio of the ceramic fine particles to the polymer resin is x:1, and x is 0.15 to 3.

9. The radiative cooling paint according to claim 1, wherein the paint film layer is formed to have a thickness of 300 μm or less.

10. The radiative cooling paint according to claim 1, further comprising at least one additive of a conditioning agent and a photoinitiator to improve painting workability.
